(19) United States
(12) Patent Application Publication
(10) Pub. No.: US 2012/0092521 A1
(43) Pub. Date: Apr. 19, 2012

(54) IMAGE PROCESSING APPARATUS HAVING FUNCTION OF CORRECTING IMAGE BASED ON AMBIENT ILLUMINATION, AND IMAGE PROCESSING METHOD

(75) Inventor: Sung Yong LEE, Gunpo (KR)

(73) Assignee: HYNIX SEMICONDUCTOR INC., Icheon-si (KR)

(21) Appl. No.: 13/249,590

(22) Filed: Sep. 30, 2011

(30) Foreign Application Priority Data
Oct. 13, 2010 (KR) 10-2010-0099833

(51) Int. Cl. H04N 9/73; H04N 9/68

(52) U.S. Cl. 348/223.1; 348/234; 348/E09.051

(57) ABSTRACT

An image processing apparatus includes: an illumination sensor sensing the intensity of illumination; an image signal processing unit processing an input image signal obtained from an image sensor unit; and a codec unit coding image signal information obtained by the image signal processing unit to obtain a luminance coefficient representing a luminance signal of an image, and adjusting the luminance coefficient according to an ambient intensity of illumination sensed by the illumination sensor.

### CROSS-REFERENCE TO RELATED APPLICATIONS

This application claims the priority of Korean Patent Application No. 10-2010-0099833 filed on Oct. 13, 2010, in the Korean Intellectual Property Office, the disclosure of which is incorporated herein by reference.

### BACKGROUND OF THE INVENTION

1. Field of the Invention

The present invention relates to an image processing apparatus and method and, more particularly, to an image processing apparatus and method capable of correcting an image obtained from an image sensor unit by using ambient illumination information.

2. Description of the Related Art

Currently, a digital camera, installed in mobile phones and the like, or produced as an individual product, includes an image sensor such as a CMOS image sensor. The image sensor converts a light signal into an electrical signal according to the brightness, wavelength, and the like, of light transferred to each pixel in an image capture mode. An input image signal obtained through the image sensor is converted into an image signal such as RGB, YCbCr, or the like, through image signal processing (ISP), and the converted image signal is input to a codec, in which image information is compressed.

For example, in the case of JPEG, an international standard regarding the compression of a color still image, a signal which has undergone ISP is discrete cosine transformed (DCT) in a codec, and image information after the DCT is quantized so as to be coded. Image information obtained in an image capture mode is processed through the foregoing image sensor, the ISP, and the codec and is then stored as an image file according to a corresponding standard. Meanwhile, in reproducing a stored image file, in order to decode compressed image information, the stored image file is dequantized and inverse discrete cosine transformed (IDCT) in the codec, converted into a reproducible image signal through the ISP process, and then displayed through a display device such as a liquid crystal display (LCD), or the like.

When the stored image file is reproduced through the image processing and displayed on a display, the quality of the image may be degraded according to ambient brightness (or ambient intensity of illumination) or the actual intensity of illumination at the time of the capturing of the image may not be properly realized. For example, when an image is captured against the light or when the surroundings are too dark or bright, a final image obtained through the general image signal processing and image compression is deviated greatly from an image quality level with which the image is visible through actual human eyes.

In order to improve the degradation of the image quality over the ambient brightness, luminance information (e.g., a Y value) of pixels obtained by processing an image signal may be used. An original signal of an input image signal of the image sensor may be amplified by using the luminance information of the pixel level or an integration time or an exposure time of the input image signal may be lengthened to receive a larger amount of light when the surroundings are dark. However, this technique significantly degrades a frame rate in the case of video and a sufficient image correction in consideration of information regarding ambient intensity of illumination is not made, resulting in a still poor picture quality of the final image when displayed.

### SUMMARY OF THE INVENTION

An aspect of the present invention provides an image processing apparatus capable of detecting an ambient intensity of illumination and correcting an image according to the detected intensity of illumination, thus acquiring a high quality image.

Another aspect of the present invention provides an image processing apparatus capable of detecting an ambient intensity of illumination and correcting an image according to the detected intensity of illumination, thus acquiring a high quality image.

According to an aspect of the present invention, there is provided an image processing apparatus including: an illumination sensor sensing the intensity of illumination; an image signal processing unit processing an input image signal obtained from an image sensor unit; and a codec unit coding image signal information obtained by the image signal processing unit to obtain a luminance coefficient representing a luminance signal of an image, and adjusting the luminance coefficient according to an ambient intensity of illumination sensed by the illumination sensor.

The coding may include discrete cosine transforming (DCT), and the luminance coefficient may be a DC coefficient representing the luminance signal of the image.

According to another aspect of the present invention, there is provided an image processing method including: obtaining an input image signal from an image sensor unit and detecting the intensity of illumination around the image sensor unit by an illumination sensor; processing the input image signal obtained from the image sensor unit; coding image signal information obtained from the image signal processing operation to obtain a luminance coefficient representing a luminance signal of an image; and adjusting the luminance coefficient representing the luminance signal according to the ambient intensity of illumination sensed by the illumination sensor.

According to another aspect of the present invention, there is provided an image processing method including: obtaining an input image signal from an image sensor unit and detecting the intensity of illumination around the image sensor unit by an illumination sensor; processing the input image signal obtained from the image sensor unit; and storing the image information obtained from the image signal processing operation as a file, wherein the image signal processing operation includes using luminance information corrected according to the ambient intensity of illumination sensed by the illumination sensor in at least one function block using luminance information included in the input image information obtained from the image sensor unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram of an image processing apparatus according to an exemplary embodiment of the present invention;

FIG. 2 is a conceptual view for explaining DCT processing performed to obtain a luminance coefficient by a codec unit of the image processing apparatus according to an exemplary embodiment of the present invention;

FIG. 3 is a schematic block diagram of an image processing apparatus according to another exemplary embodiment of the present invention;

FIG. 4 is a flow chart illustrating the process of an image processing method according to an exemplary embodiment of the present invention;

FIG. 5 is a flow chart illustrating the process of an image processing method according to another exemplary embodiment of the present invention; and

FIG. 6 is a flow chart illustrating the process of an image processing method according to another exemplary embodiment of the present invention.

### DETAILED DESCRIPTION OF THE PREFERRED EMBODIMENT

Exemplary embodiments of the present invention will now be described in detail with reference to the accompanying drawings. The invention may however be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

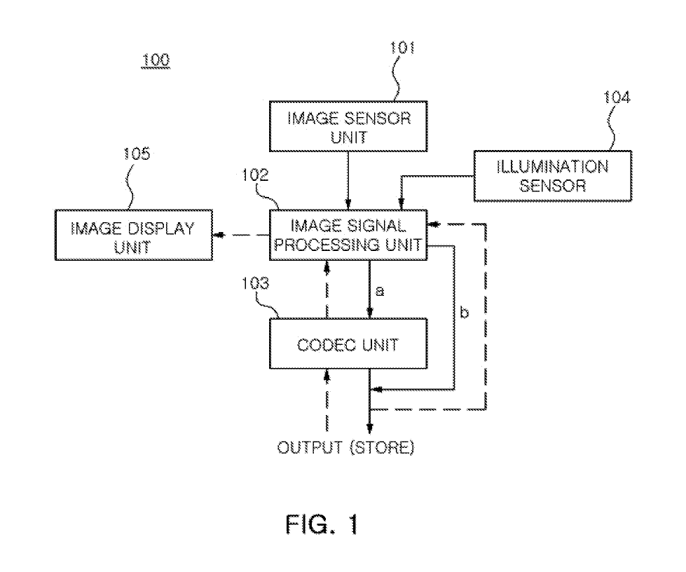

FIG. 1 is a schematic block diagram of an image processing apparatus according to an exemplary embodiment of the present invention. With reference to FIG. 1, an image processing apparatus 100 includes an illumination sensor 104, an image signal processing unit 102, and a codec unit 103. The image sensor unit 101, having a plurality of pixels, acquires an input image signal in an image capture mode. The image sensor unit 101 may be, for example, a CMOS image sensor. The illumination sensor 104, a separate element from the image sensor unit 101, senses the intensity of illumination around the image sensor to obtain ambient illumination information. For example, the illumination sensor 104 may be disposed at an outer side of the image sensor unit 104 so as to be separated from the image sensor unit 101.

The image signal processing unit 102 processes the input image signal obtained by the image sensor unit 102 to convert the input image signal into an image such as RGB, YCbCr, and the like. Also, the image signal processing unit 102 may receive the ambient illumination information obtained by the illumination sensor 104 and store the received ambient illumination information in a register therein.

The codec unit 103 codes the image signal information obtained by the image signal processing unit 102 and performs decoding on a compressed image file. For example, when an image is acquired according to a JPEG standard and stored (image capture mode), the codec unit 103 may perform DCT processing on the image signal information which has been converted by the image signal processing unit 102 and quantize the same to code it. Conversely, when an image is reproduced from an image file, which has been compressed and stored, and displayed (reproduction mode), the codec unit 103 dequantizes the image from a JPEG file and performs IDCT processing thereon to decode it. The codec unit 103 codes the image signal information obtained by the image signal processing unit 102 to obtain a luminance coefficient representing a luminance signal of the image. For example, when the codec unit 103 performs DCT processing, a DC component of a Y value (luminance value) representing a luminance signal, namely, a DC coefficient representing a luminance signal (a DC coefficient related to the luminance signal), of the image, can be obtained. Also, when the DCC value related to the luminance signal obtained by dequantizing the luminance information stored in the compressed image file, the Y value can be obtained. In FIG. 1, solid line arrows indicate the process of acquiring and storing the image, and dotted line arrows indicate the process of reproducing and displaying the image.

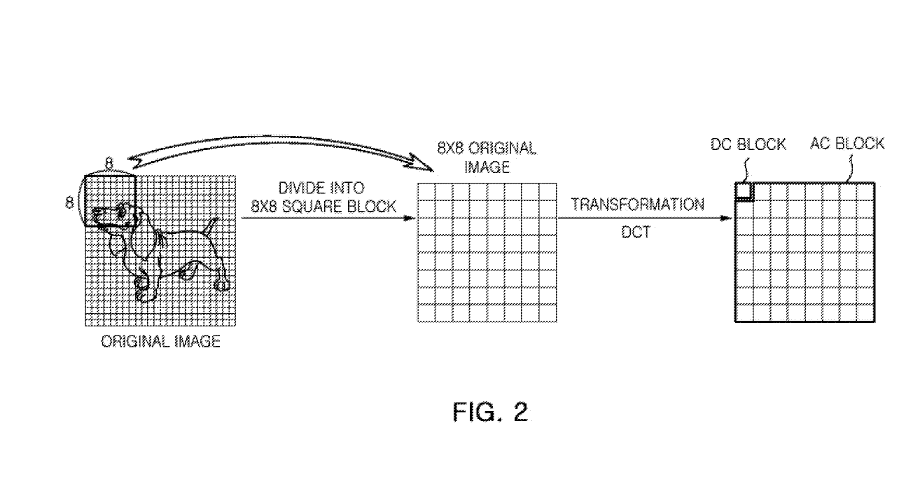

FIG. 2 is a conceptual view for explaining DCT processing performed to obtain a luminance coefficient by the codec unit 103 of the image processing apparatus according to an exemplary embodiment of the present invention. With reference to FIGS. 1 and 2, the codec unit 103 can obtain a DC component and an AC component as well as DCT coefficients, by converting original image data obtained by the image signal processing unit 102 into a frequency domain through DCT processing in a spatial domain. In detail, when the original image data is received by the codec unit 103, the codec unit 103 divides the entirety of pixels (e.g., 2048×2048 pixels, etc.) displaying the original image into square blocks each having n×n pixels, e.g., 8×8 pixels. The codec unit 103 performs DCT calculation on each of the divided square blocks to obtain a DC block representing a DC component of a luminance value and an AC block representing an AC component, among the DCT coefficients, respectively. For example, as shown in FIG. 2, the codec unit 103 may obtain a DC block and an AC block at a left upper end with respect to each of the square blocks having 8×8 pixels.

The codec unit 103 may add or subtract a certain value to or from the foregoing luminance coefficient (e.g., the DC coefficient representing the luminance signal of the image obtained through DCT processing) according to the ambient intensity of illumination stored in the register of the image signal processing unit 102 after being sensed by the illumination sensor 104, thus adjusting the luminance coefficient according to the ambient intensity of illumination. The corrected DC coefficient related to the luminance signal is stored in the form of an image file format such as JPEG, or the like, as image information. When the image is reproduced from the stored image file and displayed on an image display unit 105 such as an LCD, or the like, the DC coefficient, which has been corrected according to the ambient intensity of illumination, is IDCT-processed. Accordingly, RGB or YCbCr image information obtained through the IDCT processing can be displayed as a high quality image reflecting the ambient intensity of illumination.

When the DC coefficient representing the luminance signal is adjusted according to the ambient intensity of illumination, the codec unit 103 may determine a boundary value (i.e., a threshold value) of the ambient intensity of illumination to adjust the DC coefficient related to the luminance signal. For example, when an ambient intensity of illumination sensed by the illumination sensor 104 exceeds a pre-set range (p-q) of intensity of illumination (namely, when the ambient intensity of illumination sensed by the illumination sensor 104 is greater than the pre-set value (p) of intensity of illumination), the codec unit 103 may reduce the DC coefficient related to the luminance signal.

When an ambient intensity of illumination sensed by the illumination sensor 104 is not within the pre-set range (p-q) of intensity of illumination (namely, when the ambient intensity of illumination sensed by the illumination sensor 104 is smaller than the pre-set value (p) of intensity of illumination), the codec unit 103 may increase the DC coefficient related to the luminance signal. In this case, the decrement or increment of the DC coefficient may vary depending on the difference between the pre-set value of intensity of illumination (p or q) and the sensed illumination value. In this manner, the picture quality and the sense of reality of the image output by the image sensor can be improved and a reduction in a frame rate can be lessened by adjusting the DC coefficient according to the ambient intensity of illumination. As described above, the codec unit 103 is able to adjust the luminance coefficient in the process of acquiring and storing the image (image capture mode).

The codec unit 103 may adjust the luminance coefficient in the process of reproducing and displaying an image (reproduction mode). For example, the codec unit 103 may obtain the luminance-related DC coefficient, generate an image file format such as JPEG, or the like, reflecting the information regarding the DC coefficient (not adjusted according to the ambient intensity of illumination), and store information regarding an ambient intensity of illumination in a tag of the image file. The codec unit 103 may store the image information in a JPEG file format, and in this case, the codec unit 103 may store the information regarding the ambient intensity of illumination sensed by the illumination sensor 104 in an EXIF tag of the JPEG file. In this case, before performing decoding (e.g., decoding including IDCT processing) in the reproduction mode, the codec unit 103 may adjust the luminance coefficient (e.g., the DC coefficient related to the luminance signal) obtained from the image file according to the ambient intensity of illumination stored in the tag of the image file. In this manner, because the IDCCT processing is performed on the DC coefficient related to the luminance signal adjusted according to the ambient intensity of illumination, luminance information of the image corrected according to the ambient intensity of illumination can be obtained, and after the image signal reflecting the corrected luminance information is processed by the image signal processing unit 102, an image can be displayed by the image display unit 105.

As discussed above, the image can be displayed with accurate intensity of illumination by adjusting the luminance coefficient (e.g., the DC coefficient related to the luminance signal) according to the ambient intensity of illumination sensed by the illumination sensor 104 in the image capture mode or the reproduction mode. Also, unlike the existing scheme in which an image signal is amplified by using luminance information of a pixel level or an exposure time thereof is adjusted, in the present exemplary embodiment, the codec unit 103 adjusts the DC coefficient according to the ambient intensity of illumination, so the frame rate is not reduced and a circuit for amplifying a signal or adjusting an exposure time is not required. Also, because the results of direct sensing of intensity of illumination are reflected on the DC coefficient, a high quality image can be displayed with the accurate intensity of illumination.

The ambient intensity of illumination sensed by the illumination sensor 104 may be used for a function block of the image signal processing unit 102. Namely, at least one function block within the image signal processing unit 102 using the luminance-related information (e.g., the Y value in the JPEG standard) included in the input image information obtained by the image sensor unit may use the luminance information corrected according to the ambient intensity of illumination stored in the register of the image signal processing unit. For example, at least one of function blocks such as an AWB (Auto White Balance) gain block, a gamma correction block, and a 3A (Auto Exposure, Auto White Balance, Auto Focus) block, may use the luminance information (e.g., the Y value) corrected according to the ambient intensity of illumination obtained through the illumination sensor 104, thus performing image signal processing reflecting the accurate ambient intensity of illumination.

The image processing apparatus 100 codes or decodes the image signal information through the codec unit 103 in the process of acquiring and reproducing the image (arrow ‘a’), but this process may be omitted and the image information may be stored or displayed without performing the process (arrow ‘b’). In the process of acquiring and storing the image, the image signal information processed by the image signal processing unit 102 may be stored in a low format, rather than being coded by the codec unit 103. In this case, in the process of reproducing the image, the image signal information may be processed by the image signal processing unit 103, without passing through the codec unit 103, and the processed image is displayed on the image display unit 105. However, as mentioned above, the function block within the image signal processing unit 102 may use the luminance information corrected according to the ambient intensity of illumination to thus obtain a high quality image according to the ambient intensity of illumination.

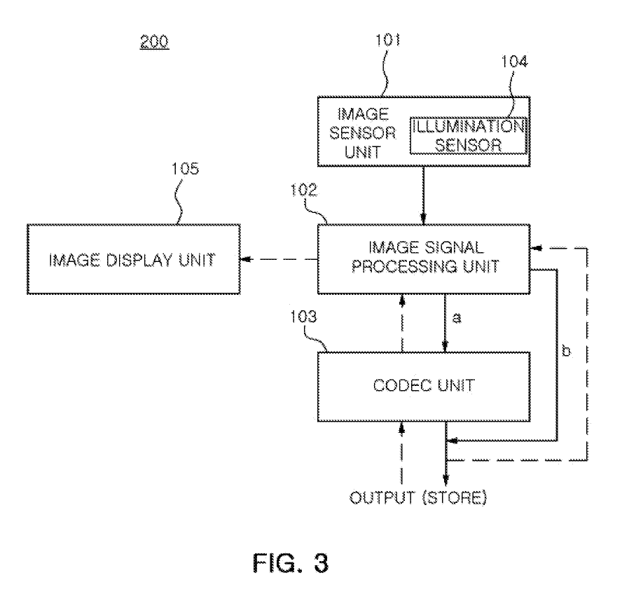

FIG. 3 is a schematic block diagram of an image processing apparatus according to another exemplary embodiment of the present invention. An image processing apparatus 200 is the same as the image processing apparatus 100 described above with reference to FIG. 1, except that the illumination sensor 104 is installed in the image sensor unit 110. For example, the illumination sensor 104 may exist as a circuit element installed in the CMOS image sensor chip.

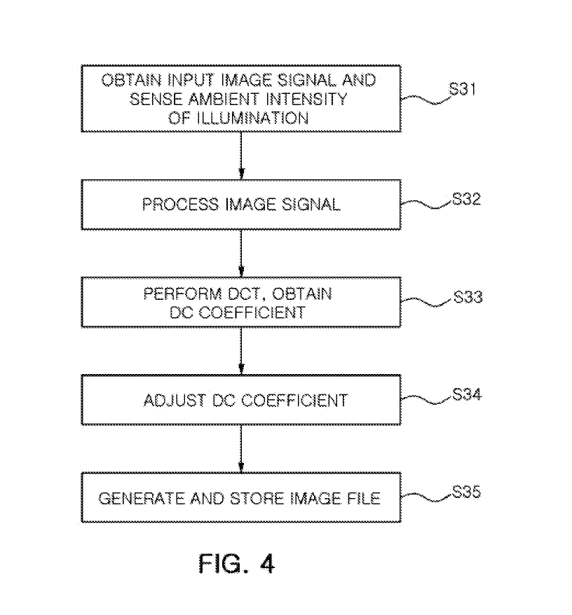

FIG. 4 is a flow chart illustrating the process of an image processing method according to an exemplary embodiment of the present invention. With reference to FIG. 4, first, the image sensor unit 101 acquires an input image signal and senses the intensity of illumination around the image sensor unit 101 by means of the illumination sensor 104 (step S31). The image sensor 101 then processes the acquired input image signal to convert it into an image such as RGB, YCbCr, or the like (step S32). The information regarding the ambient intensity of illumination obtained by the image sensor unit 101 may be stored in the register of the image signal processing unit 102. Next, the codec unit 103 performs DCT processing on the image signal information obtained by processing the image signal to obtain a DC coefficient representing a luminance signal of the image (step S33). And then, a boundary value (or a threshold value) of the ambient intensity of illumination is determined and the DC coefficient obtained through the DCT processing is adjusted according to the ambient intensity of illumination sensed by the illumination sensor 104 to correct the DC coefficient according to the ambient intensity of illumination (step S34). A quantization process by the codec unit 103 may be performed after or before correcting the DC coefficient. An image file such as a JPEG file, or the like, is generated by using the DC coefficient related to the luminance signal corrected according to the ambient intensity of illumination and stored.

Thereafter, the image file is reproduced to thus display a high quality image reflecting the accurate ambient intensity of illumination. Also, in generating and storing the image file, the illumination information regarding the ambient intensity of illumination sensed by the illumination sensor 104 may be stored in a tag of the image file, e.g., in an EXIF tag of the JPEG file. In addition, in the step (S32) of processing the image signal, at least one function block using the luminance information included in the input image information obtained by the image sensor unit 104 may use the luminance information corrected according to the sensed ambient intensity of illumination. For example, in the image processing step, at least one of an AWB (Auto White Balance) gain block, a gamma correction block, and a 3A (Auto Exposure, Auto White Balance, Auto Focus) block may use the luminance information changed by using the information regarding the ambient intensity of illumination, to thus process a signal related to each function block.

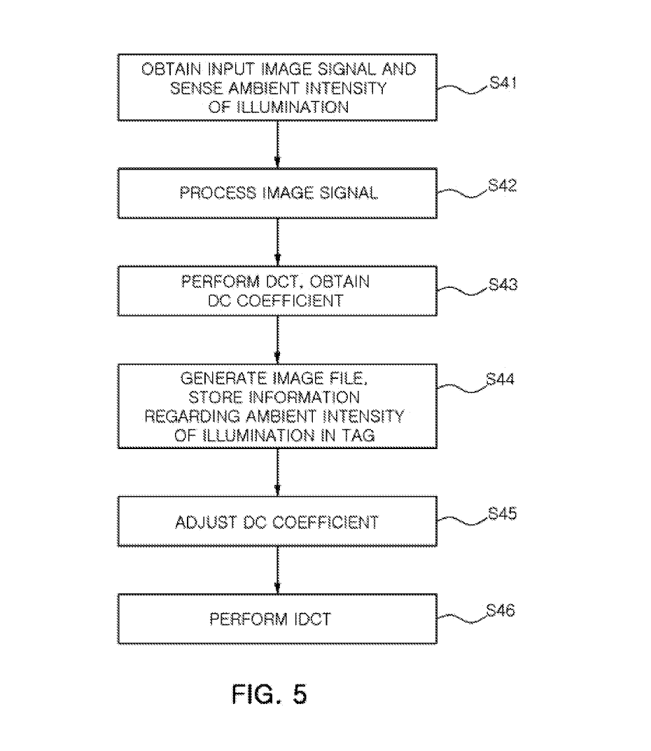

FIG. 5 is a flow chart illustrating the process of an image processing method according to another exemplary embodiment of the present invention. In the exemplary embodiment of FIG. 5, a DC coefficient related to a luminance signal according to ambient intensity of illumination is corrected in a reproduction module. First, the image sensor unit 101 obtains an input image signal and senses the intensity of illumination around the image sensor unit 101 by means of the illumination sensor 104 (step S41). The image sensor 101 then processes the acquired input image signal to convert it into an image such as RGB, YCbCr, or the like (step S42). The information regarding the ambient intensity of illumination may be stored in the register of the image signal processing unit 102. The image signal information obtained by processing the image signal is DCT-processed by the codec unit 103 to obtain a DC coefficient, and required quantization is performed on the DC coefficient to execute a coding process (step S43). An image file compressed according to the coding operation is generated and stored (step S44). In this case, the information regarding the sensed ambient intensity of illumination is stored in a tag of the image file, e.g., in the EXIF tag, or the like, of a JPEG file.

Thereafter, a decoding operation is performed to reproduce the image. Namely, the DC coefficient related to a luminance signal is corrected after or before dequantizing the DC coefficient. Namely, before performing IDCT processing, a boundary value is determined in the reproduction mode and the DC coefficient is adjusted according to the ambient intensity of illumination (step S45). And then, the DC coefficient related to the luminance signal corrected according to the ambient intensity of illumination is IDCT-processed to perform a decoding process (step S46). Thereafter, the image signal is converted through a general image signal processing procedure and a high quality image reflecting the information regarding the ambient intensity of illumination is displayed on a display device such as an LCD, or the like.

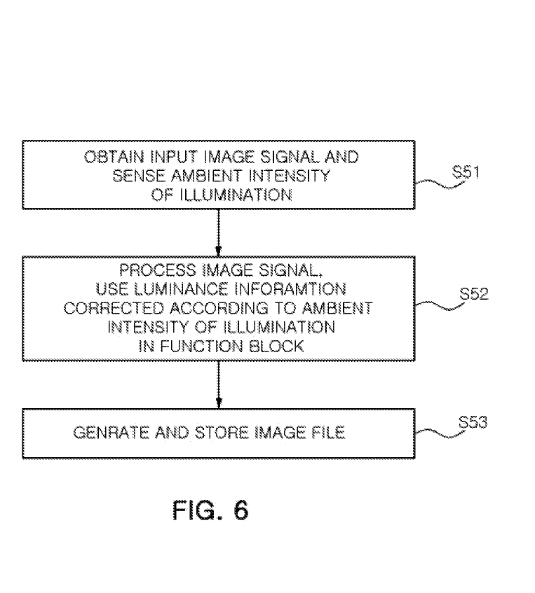

FIG. 6 is a flow chart illustrating the process of an image processing method according to another exemplary embodiment of the present invention. In the image processing method of FIG. 6, the coding or decoding process in the codec unit 103 is omitted. For example, an image file in a low format, without being compressed, is generated and stored, and reproduced. First, the image sensor unit 101 obtains an input image signal and senses an ambient intensity of illumination by means of the illumination sensor 104 (step S51). The image sensor unit 101 then processes the input image signal to convert it into an image such as RGB, YCbCr, or the like. In the image signal processing step, at least one of function blocks performing signal processing by using luminance information uses luminance information which has been corrected according to the sensed ambient intensity of illumination sensed by the illumination sensor 104 (step S52).

For example, at least one of an AWB (Auto White Balance) gain block, a gamma correction block, and a 3A (Auto Exposure, Auto White Balance, Auto Focus) block may use the luminance information corrected according to the ambient intensity of illumination, thus processing a signal of the corresponding block. Next, coding processing in the codec unit 103 is omitted, and, for example, an image file in a non-processed low format is generated and stored (step S53). Because the function block has used the luminance information corrected according to the ambient intensity of illumination in the image signal processing step, when the image file is reproduced, an image quality improved according to the ambient intensity of illumination can be obtained. For example, the gamma correction block may use a luminance gamma curved line changed according to the ambient intensity of illumination, thereby improving a dynamic range.

As set forth above, according to exemplary embodiments of the invention, a high quality image can be obtained by correcting a luminance coefficient according to an ambient intensity of illumination. Also, because information regarding an ambient intensity of illumination at the time of capturing an image is recorded, the accurate intensity of illumination can be expressed in reproducing the image, and thus, the high quality image can be displayed. In addition, because the codec adjusts the luminance coefficient according to an ambient intensity of illumination, there is no need to amplify an input image signal by using luminance information of a pixel level or there is no need to adjust an exposure time or an integration time, and thus, a high quality image can be displayed without lowering a frame rate.

While the present invention has been shown and described in connection with the exemplary embodiments, it will be apparent to those skilled in the art that modifications and variations can be made without departing from the spirit and scope of the invention as defined by the appended claims.

What is claimed is:

1. An image processing apparatus comprising:
an illumination sensor sensing the intensity of illumination;
an image signal processing unit processing an input image signal obtained from an image sensor unit; and
a codec unit coding image signal information obtained by the image signal processing unit to obtain a luminance coefficient representing a luminance signal of an image, and adjusting the luminance coefficient according to an ambient intensity of illumination sensed by the illumination sensor.

2. The apparatus of claim 1, wherein the coding comprises discrete cosine transforming (DCT), and the luminance coefficient is a DC coefficient representing the luminance signal of the image.

3. The apparatus of claim 2, wherein, in the performing of the DCT, the entire pixels are divided into square blocks, each having n×n pixels, and DCT calculation is performed on each of the divided square blocks to obtain a DC block representing a DC component of a luminance value and an AC block representing an AC component of the luminance value, respectively.

4. The apparatus of claim 1, wherein when the ambient intensity of illumination sensed by the illumination sensor is greater than a pre-set intensity of illumination, the codec unit reduces the luminance coefficient, and when the ambient intensity of illumination sensed by the illumination sensor is smaller than a pre-set intensity of illumination, the codec unit increases the luminance coefficient.

5. The apparatus of claim 1, wherein the codec unit adjusts a luminance coefficient related to a luminance signal obtained through the coding operation according to the ambient intensity of illumination sensed by the illumination sensor in an image capture mode.

6. The apparatus of claim 1, wherein the codec unit stores the illumination information regarding the ambient intensity of illumination in a tag of an image file.

7. The apparatus of claim 6, wherein the codec unit stores image information in a JPEG file format, and stores the illumination information regarding the ambient intensity of illumination in an EXIF tag of the JPEG file.

8. The apparatus of claim 6, wherein the codec unit adjusts a luminance coefficient related to a luminance signal before a decoding operation according to the ambient intensity of illumination stored in the tag of the image file in a reproduction mode.

9. The apparatus of claim 8, wherein the decoding operation comprises IDCT (Inverse Discrete Cosine Transform) processing.

10. The apparatus of claim 1, wherein the illumination sensor is installed in the image sensor unit.

11. The apparatus of claim 1, wherein the at least one function block of the image signal processing unit using the luminance information included in the input image information obtained from the image sensor unit uses luminance information which has been corrected according to the ambient intensity of illumination sensed by the illumination sensor.

12. The apparatus of claim 11, wherein the function block comprises at least one of an AWB (Auto White Balance) gain block, a gamma correction block, and a 3A (Auto Exposure, Auto White Balance, Auto Focus) block.

13. An image processing method comprising:
obtaining an input image signal from an image sensor unit and detecting the intensity of illumination around the image sensor unit by an illumination sensor;
processing the input image signal obtained from the image sensor unit;
coding image signal information obtained from the image signal processing operation to obtain a luminance coefficient representing a luminance signal of an image; and
adjusting the luminance coefficient representing the luminance signal according to the ambient intensity of illumination sensed by the illumination sensor.

14. The method of claim 13, wherein the coding comprises discrete cosine transforming (DCT), and the luminance coefficient is a DC coefficient representing the luminance signal of the image.

15. The method of claim 14, wherein, in the performing of the DCT, the entire pixels are divided into square blocks, each having n×n pixels, and DCT calculation is performed on each of the divided square blocks to obtain a DC block representing a DC component of a luminance value and an AC block representing an AC component of the luminance value, respectively.

16. The method of claim 13, wherein, in the adjusting of the luminance coefficient, when the ambient intensity of illumination sensed by the illumination sensor is greater than a pre-set intensity of illumination, the luminance coefficient is reduced, and when the ambient intensity of illumination sensed by the illumination sensor is smaller than a pre-set intensity of illumination, the luminance coefficient is increased.

17. The method of claim 13, wherein, in the adjusting of the luminance coefficient, a luminance coefficient related to a luminance signal obtained through the coding operation is adjusted according to the ambient intensity of illumination sensed by the illumination sensor in an image capture mode.

18. The method of claim 13, further comprising: storing the illumination information regarding the ambient intensity of illumination sensed by the illumination sensor, in a tag of an image file.

19. The method of claim 18, wherein the illumination information is stored in an EXIF tag of a JPEG file.

20. The method of claim 18, wherein the adjusting of the luminance coefficient comprises adjusting a luminance coefficient related to a luminance signal before a decoding operation according to the ambient intensity of illumination stored in the tag of the image file in a reproduction mode.

21. The method of claim 20, wherein the decoding operation comprises IDCT (Inverse Discrete Cosine Transform) processing.

22. The method of claim 13, wherein the processing of the image signal comprises: using luminance information, which has been corrected according to the ambient intensity of illumination sensed by the illumination sensor, in at least one function block of the image signal processing unit using the luminance information included in the input image information obtained from the image sensor unit.

23. The method of claim 22, wherein the function block comprises at least one of an AWB (Auto White Balance) gain block, a gamma correction block, and a 3A (Auto Exposure, Auto White Balance, Auto Focus) block.

24. An image processing method comprising:
obtaining an input image signal from an image sensor unit and detecting the intensity of illumination around the image sensor unit by an illumination sensor;
processing the input image signal obtained from the image sensor unit; and
storing the image information obtained from the image signal processing operation as a file,
wherein the image signal processing operation includes using luminance information corrected according to the ambient intensity of illumination sensed by the illumination sensor in at least one function block using luminance information included in the input image information obtained from the image sensor unit.

25. The method of claim 24, wherein the function block comprises at least one of an AWB (Auto White Balance) gain block, a gamma correction block, and a 3A (Auto Exposure, Auto White Balance, Auto Focus) block.
